(19) United States
(12) Patent Application Publication
(10) Pub. No.: US 2024/0242486 A1
(43) Pub. Date: Jul. 18, 2024

(54) ELECTRONIC DEVICE FOR PROVIDING IMAGE FOR TRAINING OF ARTIFICIAL INTELLIGENCE MODEL AND OPERATION METHOD THEREOF

(71) Applicant: Samsung Electronics Co., Ltd., Suwon-si (KR)

(72) Inventor: Byeongju PARK, Suwon-si (KR)

(21) Appl. No.: 18/413,756

(22) Filed: Jan. 16, 2024

Related U.S. Application Data
(63) Continuation of application No. PCT/KR2024/000698, filed on Jan. 15, 2024.

(30) Foreign Application Priority Data
Jan. 16, 2023 (KR) 10-2023-0005915
Feb. 14, 2023 (KR) 10-2023-0019628

(51) Int. Cl. G06V 10/774; G06V 10/26; G06V 10/764; G06V 10/77

(52) U.S. Cl. CPC G06V 10/774; G06V 10/267; G06V 10/764; G06V 10/7715

(57) ABSTRACT

A method performed by an electronic device is provided. The method includes identifying, by the electronic device, a first image corresponding to a first scene identifier, by using a first artificial intelligence (AI) model and the first image, identifying, by the electronic device, at least one first area contributing to classification of the first image as the first scene identifier, identifying, by the electronic device, training data for the first AI model by performing first processing for changing a pixel value of at least a part of the at least one first area of the first image.

### CROSS-REFERENCE TO RELATED APPLICATION(S)

This application is a continuation application, claiming priority under § 365(c), of an International application No. PCT/KR2024/000698, filed on Jan. 15, 2024, which is based on and claims the benefit of a Korean patent application number 10-2023-0005915, filed on Jan. 16, 2023, in the Korean Intellectual Property Office, and of a Korean patent application number 10-2023-0019628, filed on Feb. 14, 2023, in the Korean Intellectual Property Office, the disclosure of each of which is incorporated by reference herein in its entirety.

### BACKGROUND

### 1. Field

The disclosure relates to an electronic device for providing an image for training of an artificial intelligence (AI) model and an operation method thereof.

### 2. Description of Related Art

An electronic device may adjust the performance (which may be, but is not limited to, for example, a central processing unit (CPU) clock within the electronic device) of the electronic device, based on a current state (which may be, but is not limited to, for example, frames per second (FPS) and/or temperature for the output of a display). The electronic device may select a policy for a performance control based on the current state, and may control performance based on the selected policy. For example, in an overheat state, the electronic device may select a policy for reducing a CPU clock, and may control the performance of the electronic device, based on the selected policy. When a specific application (e.g., a game application) is executed, the electronic device may identify whether an index required by the application is satisfied. If the index required by the application is not satisfied, the electronic device may control performance by changing a policy. In order to accurately determine whether the index required for the specific application is satisfied, more accurate monitoring of the current state may be required.

The above information is presented as background information only to assist with an understanding of the disclosure. No determination has been made, and no assertion is made, as to whether any of the above might be applicable as prior art with regard to the disclosure.

### SUMMARY

### Technical Solution

Aspects of the disclosure are to address at least the above-mentioned problems and/or disadvantages and to provide at least the advantages described below. Accordingly, an aspect of the disclosure is to provide an electronic device for providing an image for training of an artificial intelligence (AI) model and an operation method thereof.

Additional aspects will be set forth in part in the description which follows and, in part, will be apparent from the description, or may be learned by practice of the presented embodiments.

In accordance with an aspect of the disclosure, a method performed by an electronic device is provided. The method includes identifying, by the electronic device, a first image corresponding to a first scene identifier. The method further includes, by using a first artificial intelligence (AI) model and the first image, identifying, by the electronic device, at least one first area contributing to classification of the first image as the first scene identifier and identifying, by the electronic device, training data for the first AI model by performing first processing for changing a pixel value of at least a part of the at least one first area of the first image.

In accordance with another aspect of the disclosure, an electronic device is provided. The electronic device includes memory storing one or more computer programs including computer-executable instructions, and one or more processors, wherein the computer-executable instructions, when executed by the one or more processors, cause the electronic device to identify a first image corresponding to a first scene identifier, identify at least one first area contributing to classification of the first image as the first scene identifier by using a first AI model and the first image, and identify training data for the first AI model by performing first processing for changing a pixel value of at least a part of the at least one first area of the first image.

In accordance with another embodiment aspect of the disclosure, one or more non-transitory computer-readable storage media storing one or more computer programs including computer-executable instructions that, when executed by one or more processors of an electronic device, cause the electronic device to perform operations are provided. The operations include identifying, by the electronic device, a first image corresponding to a first scene identifier. The operations further include, by using a first AI model and the first image, identifying, by the electronic device, at least one first area contributing to classification of the first image as the first scene identifier, and identify, by the electronic device, training data for the first AI model by performing first processing for changing a pixel value of at least a part of the at least one first area of the first image.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a diagram illustrating an operation method of the electronic device according to an embodiment of the disclosure;

FIG. 3A illustrates FPS and temperature observed during an in-play scene and a not-in-play scene according to an embodiment of the disclosure;

FIG. 3B illustrates an average FPS value when both an in-play scene and a not-in-play scene are considered, and an average FPS value when only an in-play scene is considered according to an embodiment of the disclosure;

FIG. 3C illustrates an FPS variation value when both an in-play scene and a not-in-play scene are considered, and an FPS variation value when only an in-play scene is considered according to an embodiment of the disclosure;

FIG. 3D illustrates an average temperature value when both an in-play scene and a not-in-play scene are considered, and an average temperature value when only an in-play scene is considered according to an embodiment of the disclosure;

FIGS. 3E and 3F may illustrate AI accuracies for respective different electronic device types according to various embodiments of the disclosure;

FIG. 4A illustrates a flowchart illustrating an operation method of the electronic device according to an embodiment of the disclosure;

FIG. 4B is a diagram illustrating policy determination according to an embodiment of the disclosure;

FIG. 5 is a flowchart illustrating a method of training an AI model according to an embodiment of the disclosure;

FIG. 6A illustrates a flowchart illustrating an operation method of a trainer according to an embodiment of the disclosure;

FIG. 6B is a diagram illustrating training data generation according to an embodiment of the disclosure;

FIG. 6C is a diagram illustrating training data generation in accordance with black-processing according to an embodiment of the disclosure;

FIG. 7A illustrates a flowchart illustrating an operation method of a trainer according to an embodiment of the disclosure;

FIGS. 7B and 7C are diagrams illustrating a structure of an AI model according to various embodiments of the disclosure;

FIG. 8A illustrates a flowchart describing an operation method of a trainer according to an embodiment of the disclosure;

FIG. 8B illustrates a flowchart describing an operation method of a trainer according to an embodiment of the disclosure;

FIG. 8C is a diagram describing determination on whether training data satisfies a designated condition, according to an embodiment of the disclosure;

FIG. 9 illustrates a flowchart describing an operation method of the electronic device according to an embodiment of the disclosure;

FIG. 10A illustrates a flowchart describing an operation method of a trainer according to an embodiment of the disclosure;

FIG. 10B is a diagram illustrating application of a Gaussian filter according to an embodiment of the disclosure;

FIG. 11 illustrates a flowchart describing an operation method of the electronic device according to an embodiment of the disclosure;

FIG. 12 illustrates a flowchart describing an operation method of the electronic device according to an embodiment of the disclosure;

FIG. 13 is a diagram illustrating the electronic device and a server according to an embodiment of the disclosure; and

FIG. 14 is a diagram illustrating operations of a wearable electronic device, the electronic device, and the server according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

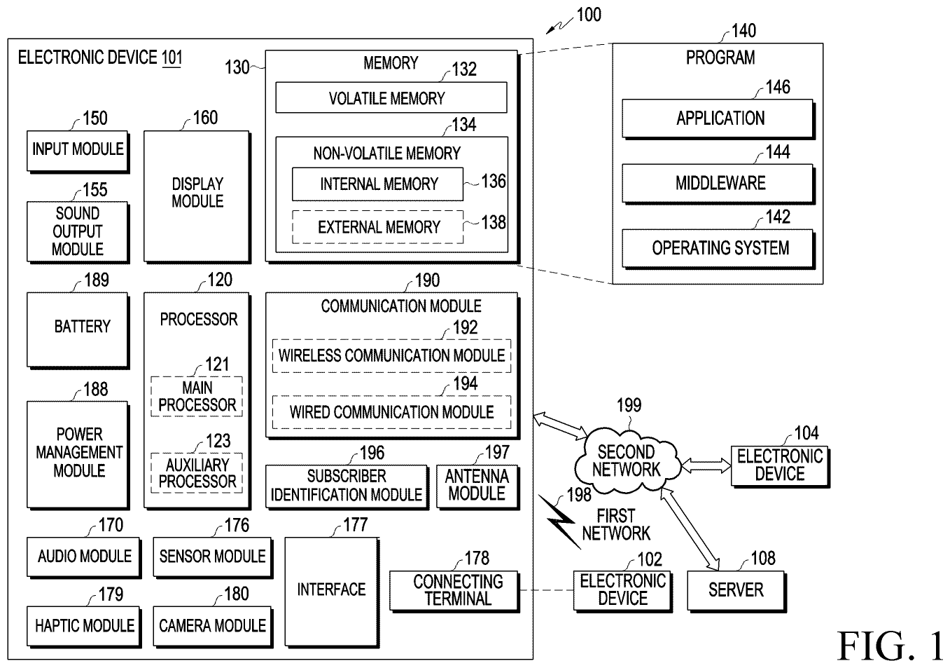

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

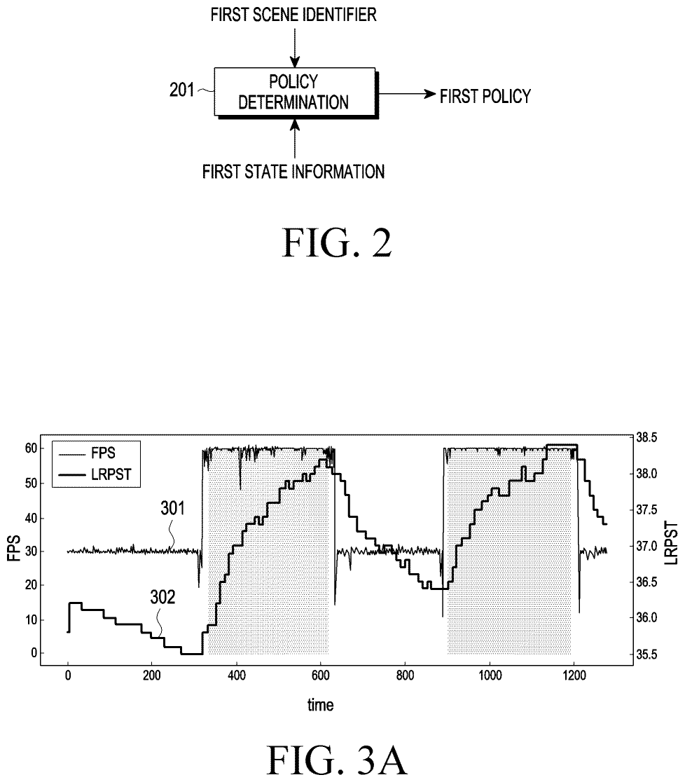

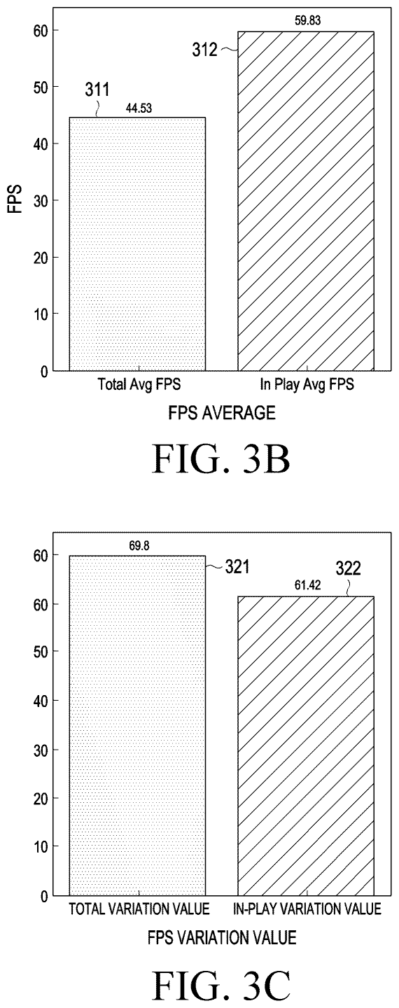

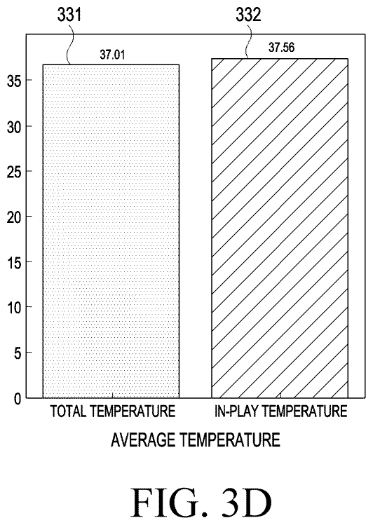

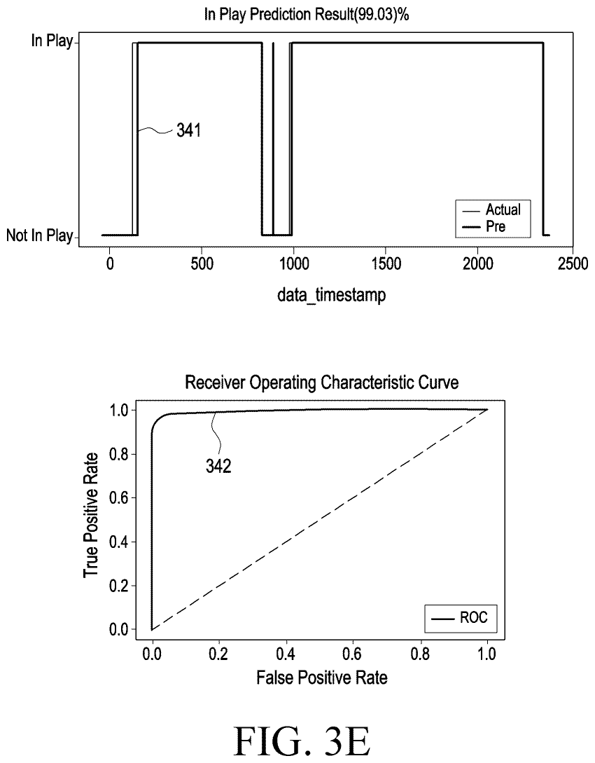

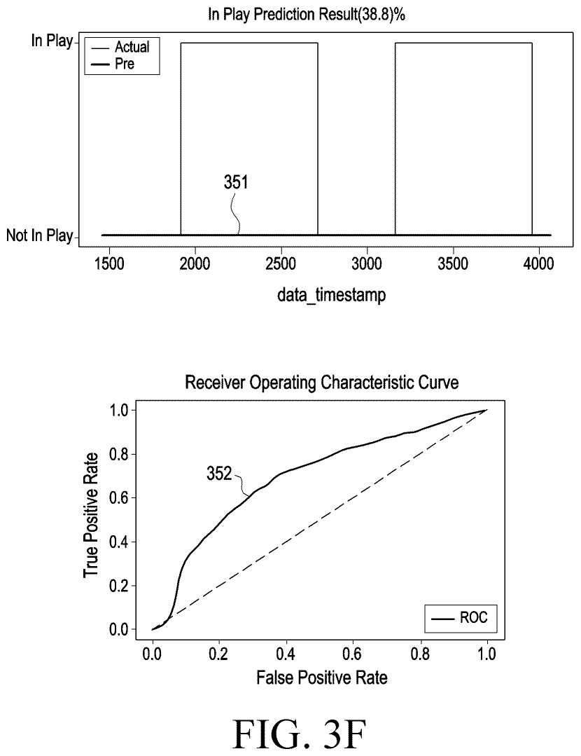

FIG. 2 is a diagram illustrating an operation method of the electronic device according to an embodiment of the disclosure. Those skilled in the art will understand that at least some of operations performed by the electronic device 101 according to the comparative example of FIG. 2 may be performed according to embodiments. The embodiment of FIG. 2 will be described with reference to FIGS. 3A to 3F.

Referring to FIG. 2, the electronic device 101 (e.g., the processor 120) may perform policy determination 201 based on first state information. In an example, the electronic device 101 may store at least one rule for the policy determination 201, and may determine a first policy corresponding to the first state information, based on the stored at least one rule. In an example, the electronic device 101 may store at least one AI model for the policy determination 201, and may determine the first policy corresponding to the first state information by inputting at least a part of the first state information to the at least one AI model. As described above, the electronic device 101 may determine the first policy corresponding to the first state information by using the AI model and/or based on the rule, and a method for determining the first policy is not limited.

For example, the state information may include an FPS, at least one temperature value measured in at least a part of the electronic device 101, an overheat rate, a CPU clock, a CPU load, a GPU load, a GPU clock, network-related information (e.g., input/output-related information (I/O), a type, and/or a load), a resolution, a refresh rate, and/or a brightness of the display module 160, but there are no limitations on a type of the state information. The state information, in an example, may be configured based on a statistical value (may be, for example, an average value and/or a median value, but is not limited to) for values measured during a designated period. For example, the state information may be an average value of multiple FPSs measured during a first period, but is not limited thereto. The statistical value is simply an example, and the electronic device 101 may be configured to adjust a policy in response to a state value in real time. For example, the policy may include a CPU clock and/or a GPU clock, but a type thereof is not limited.

For example, the electronic device 101 may identify whether a target FPS requested by an application being executed is satisfied. For example, it is assumed that a game application requests 60 fps as a target FPS. The electronic device 101 may identify a first FPS (e.g., 60 fps) as the first state information. The electronic device 101 may maintain a current policy (e.g., a current CPU clock and/or GPU clock), based on that the first FPS (e.g., 60 fps) satisfies the target FPS (e.g., 60 fps). For example, the electronic device 101 may identify a second FPS (e.g., 30 fps) as second state information. The electronic device 101 may determine to change the policy, based on that the second FPS (e.g., 30 fps) does not satisfy the target FPS (e.g., 60 fps). For example, the electronic device 101 may select a policy including a relatively higher CPU clock and/or GPU clock compared to the current CPU clock and/or current GPU clock. The electronic device 101 may apply the selected policy (e.g., increasing the CPU clock and/or GPU clock), and accordingly, the FPS may be increased.

Meanwhile, an application may include multiple types of scenes. For example, for a game application, a scene (e.g., a scene having an in-play scene identifier) including at least one object for game playing may exist. Alternatively, for the game application, a scene (e.g., a scene having a not-in-play scene identifier) of a screen (may be, for example, a screen representing a waiting room of an on-line game, or a screen indicating game loading, but there is no limit) other than game playing may exist. While the game application is being executed, different states of the electronic device 101 may be observed according to a scene type.

FIG. 3A illustrates FPS and temperature observed during an in-play scene and a not-in-play scene according to an embodiment of the disclosure.

Referring to FIG. 3A, it may be identified that an FPS 301 remains close to, for example, 30 fps during a not-in-play scene, and remains close to, for example, 60 fps during an in-play scene. In addition, it may be identified that, for example, temperature 302 may decrease during the not-in-play scene and may increase during the in-play scene.

FIG. 3B illustrates an average FPS value 311 when both the in-play scene and the not-in-play scene are considered, and an average FPS value 312 when only the in-play scene is considered according to an embodiment of the disclosure. For example, the average FPS value 311 when both the in-play scene and the not-in-play scene are considered may be 44.53, and the FPS average value 312 when only the in-play scene is considered may be 59.83. As described in FIG. 3A, it may be identified that the FPS 301 remains close to 30 fps in the not-in-play scene. Accordingly, the FPS average value 311 when both the in-play scene and the not-in-play scene are considered may be 44.53 that is lower than 59.83. When a scene type is not considered, the electronic device 101 may identify the fps of 44.53 as the state information, instead of the fps of 59.83, so as to adjust a policy corresponding thereto. Although there is no need to adjust the policy because the fps of 59.83, which is obtained when only the in-play scene is considered, satisfies the target FPS (e.g., 60 fps), the electronic device 101 may likely to unnecessarily increase a CPU clock and/or a GPU clock when the fps of 44.53 is identified as the state information. Accordingly, the electronic device 101 needs to determine the policy by considering only the state information during a scene (e.g., the in-play scene in the embodiment of FIG. 3A) corresponding to an index requested by an application.

FIG. 3C illustrates an FPS variation value 321 when both the in-play scene and the not-in-play scene are considered, and an FPS variation value 322 when only the in-play scene is considered according to an embodiment of the disclosure. It may be identified that there is a difference between the variation values 321 and 322, and accordingly, the electronic device 101 may identify that the policy needs to be determined by considering only the state information during the scene (e.g., the in-play scene in the embodiment of FIG. 3A) corresponding to the index required by the application. FIG. 3D illustrates an average temperature value 331 when both the in-play scene and the not-in-play scene are considered, and an average temperature value 332 when only the in-play scene is considered according to an embodiment of the disclosure. It may be identified that there is a difference between the average temperatures 321 and 322, and accordingly, the electronic device 101 may identify that the policy needs to be determined by considering only the state information during the scene (e.g., the in-play scene in the embodiment of FIG. 3A) corresponding to the index required by the application.

As described above, the electronic device 101 needs to determine the policy, based on the state information during a type of scene corresponding to the index requested by the application. Accordingly, as a recognition accuracy of the type of scene corresponding to the index required by the application increases, more accurate policy determination may be possible. For example, the electronic device 101 may identify a scene identifier output from an AI model by inputting an image constituting an application screen to the AI model. The AI model may be trained to take the image as an input value and take the scene identifier as an output value. When the AI model is trained for each type of the electronic device 101, a difference in accuracy may occur for each electronic device 101.

FIGS. 3E and 3F may illustrate an AI accuracy for each of different electronic device types according to various embodiments of the disclosure. For example, the AI model may be trained for an electronic device of a first type. FIG. 3E illustrates a scene prediction accuracy 341 and a receiver operating characteristic (ROC) curve 342 when the AI model is used in the electronic device of the first type. It may be identified that the scene prediction accuracy 341 and the ROC curve 342 are at relatively high levels. FIG. 3F illustrates a scene prediction accuracy 351 and an ROC curve 352 when the AI model is used in an electronic device of another type which is different from the first type. It may be identified that the scene prediction accuracy 351 and the ROC curve 352 are at relatively low levels. Accordingly, it may be required to precisely train the AI model for each application.

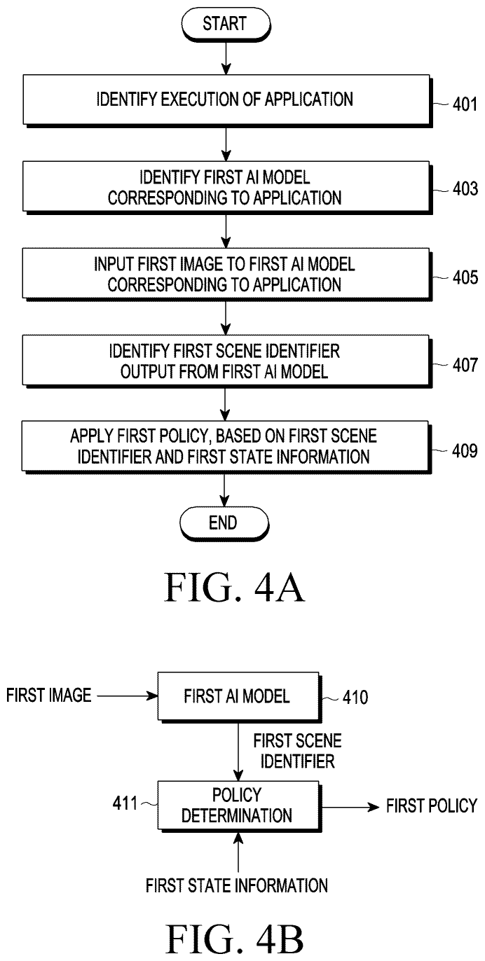

FIG. 4A illustrates a flowchart illustrating an operation method of the electronic device according to an embodiment of the disclosure. The embodiment of FIG. 4A will be described with reference to FIG. 4B. FIG. 4B is a diagram illustrating policy determination according to an embodiment of the disclosure.

Referring to FIGS. 4A and 4B together, according to an embodiment, the electronic device 101 (e.g., the processor 120) may identify execution of an application in operation 401. In operation 403, the electronic device 101 may identify a first AI model 410 corresponding to the application. For example, the electronic device 101 may identify the first AI model 410 corresponding to the application running in the foreground, and there is no limitation on execution in the foreground or execution in the background. The electronic device 101 may store, for example, at least one AI model corresponding to each of at least one application. An AI model corresponding to a specific application may be stored in the electronic device 101, but the AI model may not be stored in some cases. In this case, the electronic device 101 may request the AI model (or information related to the AI model) from the server 108, which will be described later. In the embodiment, it is assumed that the electronic device 101 stores the first AI model 410 (or information related to the first AI model) corresponding to the executed application. The electronic device 101 may identify the AI model corresponding to the executed application, based on association information between at least one application and at least one AI model, and there is no limitation on an identification scheme.

In operation 405, the electronic device 101 may input a first image (e.g., at least a partial image of an execution screen of the application) to the first AI model 410 corresponding to the application. The first image may have a format of jpeg, jfif, exif, gif, png, ppm, pgm, pbm, pnm, hdr, and/or bmp, and there is no limitation on the format. The electronic device 101 may use an image format provided from the application as it is without a change, or may change the provided image format to another format. Here, the first AI model 410 may be trained to receive an image and output a scene identifier. The first AI model 410 may have a structure of a DNN, CNN, RNN, long short-term memory (LSTM), RBM, DBN, BRDNN, and/or a deep Q-network, and there is no limitation on the structure of the first AI model 410. The first AI model 410 may receive the first image and provide a first scene identifier (or a probability of each of multiple scene identifiers) corresponding to the first image. Here, the first scene identifier may be, for example, an in-play identifier or a not-in-play scene identifier. The aforementioned two types of scene identifiers are simply examples, and the first AI model 410 may be implemented to have a structure for determining (or providing a probability of each type) one of three or more types of scene identifiers. For example, Table 1 is an example of a scene identifier.

TABLE 1

| Scene | |
|---|---|
| identifier | Scene-related information |
| 0 | Default scene |
| 1 | Game in-start |
| 2 | Game in-update |
| 3 | User in-access |
| 4 | In waiting room |
| 5 | Scene for game in-load (user in-load) |
| 6 | Scene for game in-load (another user in-load) |
| 7001 | Game in-play (scene #1: chatting with NPC) |
| 7002 | Game in-play (scene #2: fighting against a first |
| | character at a first place) |
| 7003 | Game in-play (scene #3: fighting against a second |
| | character at a second place) |
| . . . | . . . |
| 8 | Spectator mode |
| 9 | Game over |

For example, as shown in Table 1, scene identifiers may be assigned in detail to respective multiple examples for in-play and/or multiple examples for not-in-play, and there is no limitation on type and/or classification criteria of the scene identifiers.

In operation 407, the electronic device 101 may identify the first scene identifier output from the first AI model 410. In operation 409, the electronic device 101 may apply a first policy, based on the first scene identifier and first state information.

Referring to FIG. 4B, the electronic device 101 may perform policy determination 411 using the first scene identifier as well as the first state information. The electronic device 101 may input multiple images over time (e.g., multiple application execution screens over time) to the first AI model 410. Accordingly, the electronic device 101 may identify the scene identifiers over time. The electronic device 101 may use, for policy determination, state information corresponding to a scene identifier corresponding to an index requested by the application, and may not use, for policy determination, state information corresponding to the remaining scene identifiers. For example, it is assumed that the scene identifier corresponding to the index requested by the application is an in-play scene identifier. In this case, for example, the electronic device 101 may determine the first policy by using state information during a section corresponding to the in-play scene identifier. For example, the electronic device 101 may not use, for determination of the first policy, state information during a section corresponding to the not-in-play scene identifier. The electronic device 101 may determine the first policy by using a statistical value (may be, for example, an average value and/or a mean value, but not limited thereto) corresponding to the state information during the section corresponding to the in-play scene identifier. Accordingly, unnecessary state information (e.g., the state information during the section corresponding to the not-in-play scene identifier) may be excluded from policy determination. As described above, it is assumed that, for example, a target FPS requested by the running application is 60 fps. In this case, as described in FIG. 3B, it may be identified that the FPS may be maintained to be 59.83 fps in the section corresponding to the in-play scene identifier, but an average FPS value is 44.53 in the entire section. The electronic device 101 may determine the policy by using 59.83 fps which is the state information in the section corresponding to the in-play scene identifier. For example, the electronic device 101 may maintain the existing policy by identifying that 59.83 fps, which is the state information in the section corresponding to the in-play scene identifier, satisfies the target FPS of 60 fps. Accordingly, the electronic device 101 may prevent an unnecessary increase in performance (e.g., a CPU clock and/or a GPU clock) due to using 44.53 fps obtained even in consideration of the state information in the section (e.g., the section corresponding to the not-in-play scene identifier) that is not required.

FIGS. 4A and/or 4B describe that the electronic device 101 performs policy determination 411 and/or inference of the first AI model 410. Those skilled in the art may understand that the policy determination 411 and/or inference of the first AI model 410 may be performed by, for example, an external electronic device (may be, for example, the server 108 but not limited thereto) of the electronic device 101, and results of performing same may be provided to the electronic device 101.

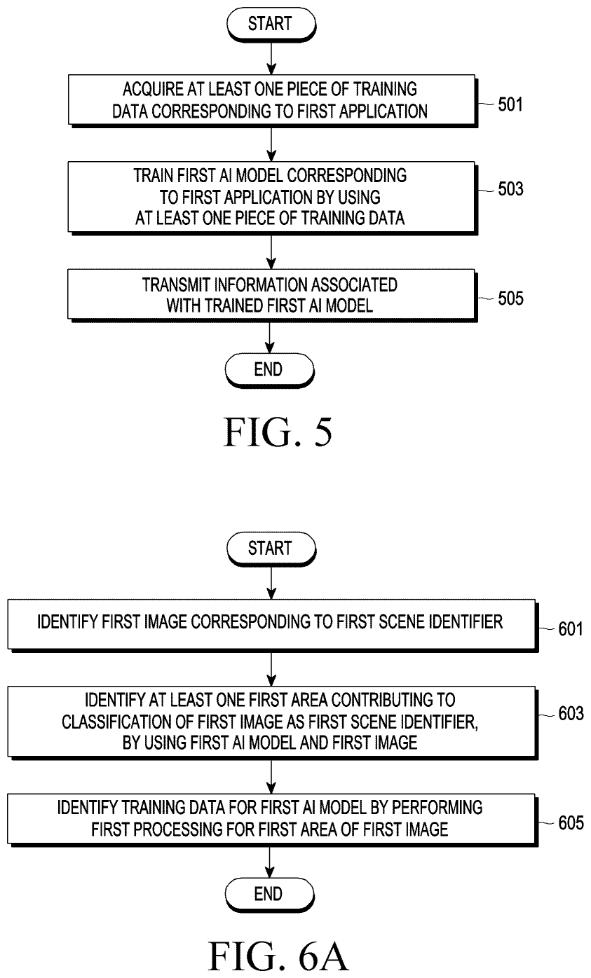

FIG. 5 is a flowchart illustrating a method of training an AI model according to an embodiment of the disclosure. According to an embodiment, training of at least one AI model may be performed by a trainer. Training may be performed, for example, by the server 108 (or may be another computing device) and/or may be performed by the electronic device 101 executing an AI model. An operation performed by the trainer in the disclosure may be understood to be performed by the electronic device 101 (or the processor 120) and/or the server 108 (e.g., a processor (not illustrated) included in the server 108).

According to an embodiment, in operation 501, the trainer may obtain at least one piece of training data corresponding to a first application. Here, the at least one piece of training data may be, for example, at least one execution screen of the first application, but is not limited thereto. As described above, a format of the training data may be jpeg, but is not limited thereto, wherein the training data may have the same format as that of the execution screen of the application or may have a different format according to format conversion. For example, the training data may be data labeled with a scene identifier. Label information may be, for example, assigned to each image, and there is no limitation on an expression method thereof. In addition, there is no limitation also on a method of expressing an image and label pair and/or a program for expressing the same. For example, the at least one piece of training data may include at least one first application execution screen corresponding to a first scene identifier (e.g., an in-play scene identifier), and the first scene identifier may be labeled on the execution screen. For example, the at least one piece of training data may include at least one first application execution screen corresponding to a second scene identifier (e.g., a not-in-play scene identifier), and the second scene identifier may be labeled on the execution screen. In operation 503, the trainer may train a first AI model corresponding to a first application by using the at least one piece of training data. For example, the trainer may train the first AI model by using at least one labeled execution screen of the first application. For example, the trainer may train the existing first AI model. For example, the trainer may generate a first AI model and train the generated first AI model. There is no limitation on a type of a loss function and/or a training scheme of the first AI model. In operation 505, the trainer may transmit information associated with the trained first AI model to a device (e.g., the electronic device 101, but not limited thereto) that infers the first AI model. Here, transmitting of the first AI model may indicate not only transmitting all information for expressing the first AI model, but also transmitting some (may be, for example, a weight value and/or bias per node, but not limited thereto) of the information for expressing the first AI model. For example, the trainer may transmit the first AI model in response to a request from the device (e.g., the electronic device 101, but not limited thereto). For example, the trainer may transmit the first AI model when installation of the application is identified. For example, the trainer may transmit the first AI model when transmitting the application (or application package). For example, the trainer may transmit the first AI model when the first AI model is updated. There is no limitation on an event for transmission of the first AI model. For example, if the performance (may be, for example, an ROC score, etc., but not limited thereto) of the trained (or updated) AI model is superior to that of an existing AI model, the trainer may perform an update to the corresponding AI model. The AI model may be called based on lambda, but this is not limited thereto. The updated AI model may be provided to the inference device.

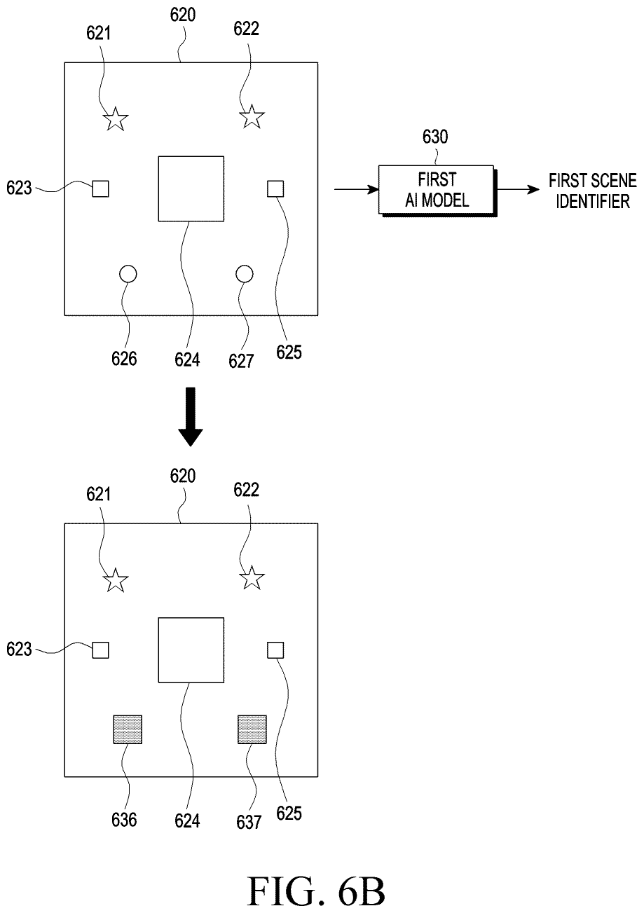

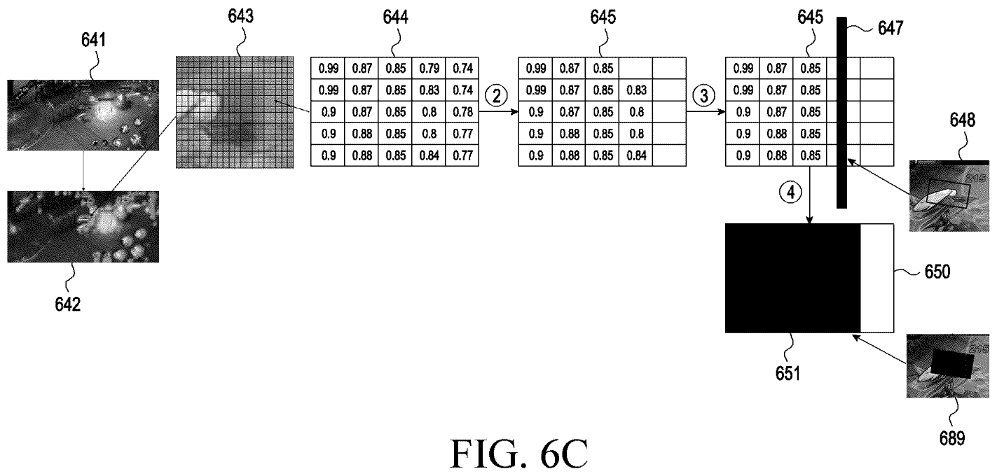

FIG. 6A illustrates a flowchart illustrating an operation method of a trainer according to an embodiment of the disclosure. The embodiment of FIG. 6A will be described with reference to FIG. 6B. FIG. 6B is a diagram illustrating training data generation according to an embodiment of the disclosure. The embodiments of FIGS. 6A and 6B describe that training data may be generated by a trainer, and there is no limitation on a performing subject. For example, a trainer and a subject that manages training data may be implemented to be different, in which case, a device which manages training data may generate training data. Alternatively, those skilled in the art may understand that a device which performs AI model inference may generate training data. The fact that at least some of operations performed by the trainer may be performed by a training data management device and/or an AI model inference device may be applied not only to this embodiment, but also to other embodiments of the disclosure.

Referring to FIGS. 6A and 6B together, according to an embodiment, in operation 601, the trainer may identify a first image 620 corresponding to a first scene identifier. Referring to FIG. 6B, the first image 620 may include at least one visual object 621, 622, 623, 624, 625, 626, and 627. The at least one visual object 621, 622, 623, 624, 625, 626, and 627 in FIG. 6B is expressed by figures of various shapes, but this is for convenience of description, wherein the shape, color, size, and/or property of the visual object included in the image is not limited. If the first image 620 is an execution screen of a game application, the first image 620 may include a visual object corresponding to a game character, a visual object corresponding to a game background, a visual object for controlling a game character, a visual object for attributes of a game character, and a visual object for a game progressing situation (e.g., stage-related information), but a type thereof is not limited, and various types of applications other than game applications may be possible.

In operation 603, the trainer may use a first AI model 630 and the first image 620 to identify at least one first area which contributes to classification of the first image 620 as a first scene identifier, for example, an area including the visual objects 626 and 627. For example, the trainer may store and/or load a condition for determination of an area contributing to classification as the first scene identifier. The condition, which will be described later, may be configured based on a feature importance. The trainer may identify an activation map corresponding to the first image 620, and the activation map may be expressed based on a feature importance. The trainer may identify an area (or an area in which a ratio of the feature importance being greater than or equal to the threshold feature importance is greater than or equal to a threshold ratio), which has a feature importance greater than or equal to a designated threshold feature importance, to be an area contributing to classification of the first image 620 as the first scene identifier.

In an embodiment, the trainer may identify an area contributing to classification of the first image 620 as the first scene identifier, based on local interpretable model-agnostic explanation (LIME). For example, the trainer may divide the first image 620 into interpretable elements. The trainer may train the AI model by processing (may be, for example, gray-processing, but not limited thereto) at least some of the divided elements. Then, when learning performance is lowered compared to the past, the trainer may identify a corresponding area as an area contributing to classification as the first scene identifier. In an embodiment, the trainer may identify an area contributing to classification of the first image 620 as the first scene identifier, based on unpooling and deconvolution. For example, a CNN may be a structure that compresses an image so as to predict a specific result. Accordingly, in a final layer of the CNN, a weight value for a part that has contributed relatively greatly to result prediction may be relatively large. A part having a relatively large weight value in an existing image may be identified by deconvolution of a corresponding layer again. The trainer may identify the corresponding part as an area contributing to classification as the first scene identifier. In an embodiment, the trainer may identify an area contributing to classification of the first image 620 as the first scene identifier, based on a class activation map (CAM). The CAM may include global average pooling in the middle to measure a variance. The trainer may identify an area contributing to classification of the first image 620 as the first scene identifier, based on guided back propagation. Guided back propagation may be a method of pre-processing and using a feature map. The aforementioned methods of identifying an area contributing to classification of the first image 620 as the first scene identifier are examples according to disclosed aspects, and are not limited thereto.

In operation 605, the trainer may perform first processing for changing a pixel value of at least a part of a first area of the first image 620, for example, an area including the visual objects 626 and 627, thereby identifying training data 630 for the first AI model. The change of the pixel value here may include, for example, black-processing of changing the pixel value to a value corresponding to black, but those skilled in the art may understand that there is no limitation on a pixel value and/or a pixel value pattern after the change. The training data 630 for the first AI model may include, for example, black-processed areas 636 and 637. As the first processing (e.g., black-processing) is performed on the first area, for example, the area including the visual objects 626 and 627, the training data 630 for the first AI model may be provided, but the black-processing is merely an example, and there is no limitation on a processing scheme. For example, the first AI model 630 may identify, as the first scene identifier, a scene identifier corresponding to the first image 620, based on the visual objects 626 and 627 of the first image 620. There is a possibility that an image, which includes no visual object capable of increasing a possibility of classification as a scene identifier, is not classified as the corresponding scene identifier. For example, there may be a possibility that the first AI model 630 is trained to classify a scene identifier, which corresponds to an image that does not include the visual objects 626 and 627, as a scene identifier other than the first scene identifier. The trainer may generate the training data 630 excluding the visual objects 626 and 627 which have made a relatively large contribution to classification as the first scene identifier. The trainer may train the first AI model 630 by using the training data 630. Accordingly, the first AI model 630 may train the first AI model 630 so that an image, which includes objects (e.g., at least some of the objects 621, 622, 623, 624, and 625) other than the visual objects 626 and 627 having made a relatively large contribution to classification as the first scene identifier, is also classified as the first scene identifier. Accordingly, the first AI model 630 may be trained based on various visual objects, and may not be over-fitted for some visual objects.

FIG. 6C is a diagram illustrating training data generation in accordance with black-processing according to an embodiment of the disclosure.

According to an embodiment, the trainer may acquire a first image 641. The first image 641 may be labeled as the first scene identifier. The trainer may acquire an activation map 642 corresponding to the first image 641. Here, each pixel (or sub-area) in the activation map 642 may be expressed using a feature importance, and a procedure of generating the activation map 642 will be described later. A first area 643 of the activation map 642 may be expressed as a first activation map 644. Each pixel (or sub-area) in the first activation map 644 may be expressed using a feature importance. The feature importance may be expressed using, for example, a value which is equal to or greater than 0 and is equal to or smaller than 1, but an expression scheme is not limited. The trainer may, for example, blank-process an area having a feature importance smaller than 0.8, and a blank-processed first activation map 645 may be identified, wherein the value of 0.8 is an example and is not limited. For example, the trainer may configure an outline (or contour) 647 for an area having a feature importance of 0.8 or greater, and the value of 0.8 is an example and is not limited. A full image 648 including the first activation map 645 in which the contour 647 is expressed may be shown in FIG. 6C. The trainer may identify an activation map 650 in which the contour and an area 651 inside the contour are black-processed. The trainer may identify, as training data, an image 689 including the black-processed area corresponding to the black-processed activation map 650. The processing according to the procedure of FIG. 6C is merely an example, and there is no limitation on a scheme of excluding an area having made a relatively large contribution to classification as a specific scene identifier (or an area satisfying a condition associated with the classification).

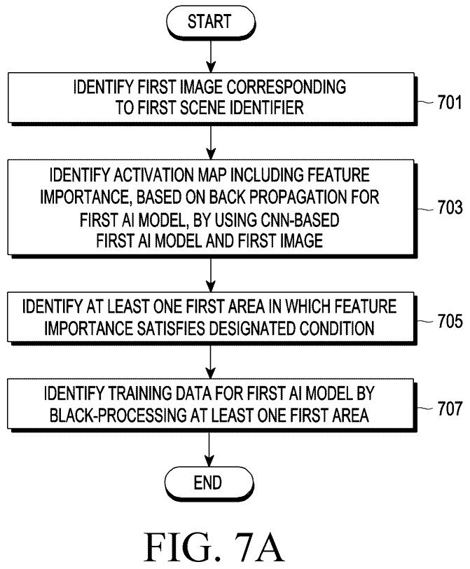

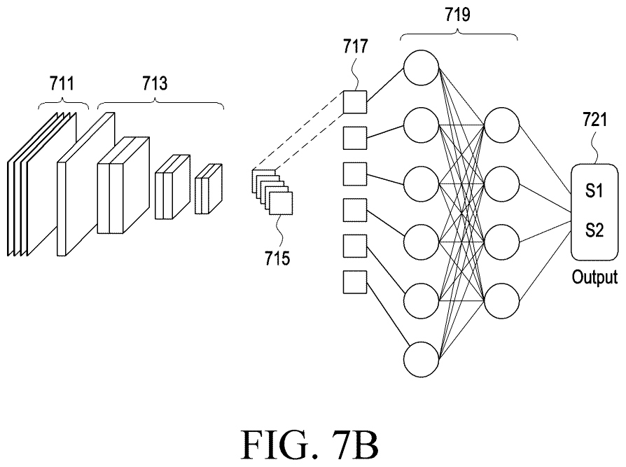

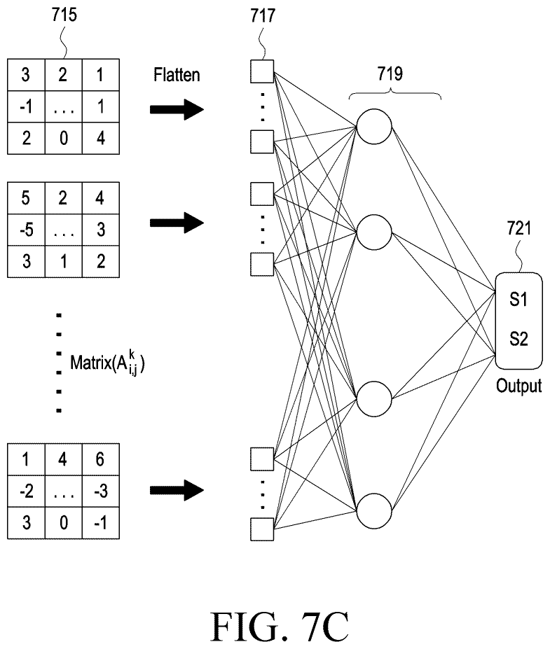

FIG. 7A illustrates a flowchart illustrating an operation method of a trainer according to an embodiment of the disclosure. The embodiment of FIG. 7A will be described with reference to FIGS. 7B and 7C. FIGS. 7B and 7C are diagrams illustrating a structure of an AI model according to various embodiments of the disclosure.

According to an embodiment, in operation 701, the trainer may identify a first image corresponding to a first scene identifier. In operation 703, the trainer may identify, using the first image and a CNN-based first AI model as shown in FIG. 7B, an activation map including a feature importance, based on back propagation for the first AI model. For example, referring to FIGS. 7B and 7C, the first AI model may include a convolution layer 713. A size and/or type of a feature constituting the convolutional layer 713 are not limited. The first image may be provided to an input layer 711. The input layer 711 may be based on, for example, multiple images for each channel corresponding to the first image. The input layer 711 may be connected to the convolution layer 713. The convolution layer 713 may output at least one feature map 715. The first AI model may include a structure for flattening at least one feature map 715. For the feature map 715, a flattened layer 717 may correspond to, for example, the feature map 715 in a matrix form. Each of the at least one feature map 715 in the matrix form may be expressed as A^{k}_{i,j}. The flattened layer 717 may be connected to a fully connected layer 719. The fully connected layer 719 may be connected to an output layer 721. The output layer 721 may include, for example, two output parameters S1 and S2. For example, a first output parameter S1 may correspond to a probability of being a first scene identifier (e.g., an in-play scene identifier) and a second output parameter S2 may correspond to a probability of being a second scene identifier (e.g., a not-in-play scene identifier). For example, when the AI model is inferred, a scene identifier corresponding to a higher value from among the two parameters S1 and S2 may be determined as a scene identifier corresponding to the first image. The output layer 721 may be expressed as y^{e}. The activation map may be generated based on back propagation for the first AI model. For example, the activation map may be determined based on Equations 1 and 2.

$${a}_{k}^{c} = \frac{1}{z} {\sum }_{i} {\sum }_{j} \frac{{\partial }_{{y}^{C}}}{\partial {A}_{i , j}^{k}} \qquad Equation 1$$

$${L}^{c} = R e LU {\sum }_{k} {a}_{k}^{c} {A}^{k} \qquad Equation 2$$

In Equations 1 and 2, c may indicate a class, for example, “1” may correspond to an in-play scene identifier, and “0” may correspond to a not-in-play scene identifier. k may be an index for a feature map (e.g., matrix). z may be a product of a row and a column of a matrix. i and j may be an i-th element and a j-th element in the matrix. According to back propagation, such as Equation 1 and Equation 2, the activation map L^{c} may be determined based on a product of a contribution degree based on a partial derivative value and the feature map, and there is no limitation on a scheme of identifying the activation map L^{c}.

Based on the above description, the activation map may be identified. In operation 705, the trainer may identify at least one first area, in which a feature importance satisfies a designated condition, in the activation map. The designated condition may be, for example, a condition in which a feature importance is greater than or equal to a threshold feature importance (e.g., 0.8), but is not limited thereto. In operation 707, the trainer may identify training data for the first AI model by black-processing the at least one first area. For example, as described with reference to the embodiment of FIG. 6C, the trainer may perform blank-processing on a part having a feature importance smaller than the threshold feature importance. The trainer may identify a contour in the blank-processed activation map. The trainer may identify an area defined by the contour. The trainer may perform black-processing on the area defined by the contour. Accordingly, the trainer may identify the black-processed activation map. The trainer may identify the training data by performing black-processing on pixels of the first image corresponding to the black-processed area in the activation map, but the procedure described above is an example and is not limited.

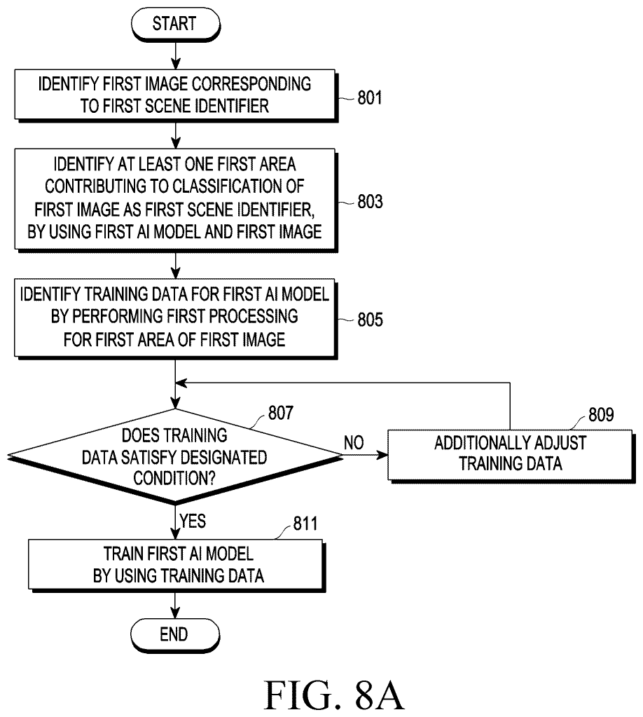

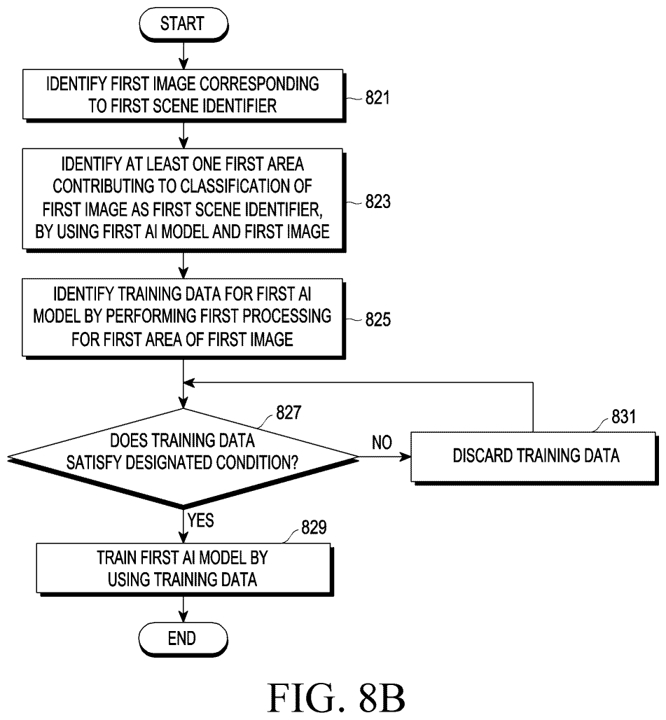

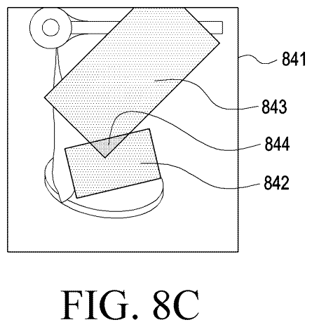

FIG. 8A illustrates a flowchart describing an operation method of a trainer according to an embodiment of the disclosure.

According to an embodiment, in operation 801, the trainer may identify a first image corresponding to a first scene identifier. In operation 803, the trainer may identify at least one first area contributing to classification of the first image as a first scene identifier, by using a first AI model and the first image. In operation 805, the trainer may identify training data for the first AI model by performing first processing for the first area of the first image. Since identification of the training data, based on operations 801, 803, and 805 has been described with reference to FIGS. 6A, 6B, and/or 6C, detailed descriptions will not be repeated here.

According to an embodiment, in operation 807, the trainer may identify whether the training data satisfies a designated condition. In an example, the trainer may identify whether a ratio that an area, in which a feature importance satisfies the designated condition (e.g., a feature importance greater than or equal to 0.8), occupies in a full activation map is greater than or equal to a threshold value (e.g., 0.25), as identification of whether the designated condition is satisfied. In an example, the trainer may identify whether the number of areas, in which a feature importance satisfies the designated condition (e.g., a feature importance greater than or equal to 0.8), is greater than or equal to a threshold number (e.g., 3), as identification of whether the designated condition is satisfied. In an example, the trainer may identify whether a size of an area, in which a feature importance satisfies the designated condition (e.g., a feature importance greater than or equal to 0.8), is greater than 1/N times a size of the activation map, as identification of whether the designated condition is satisfied. In an example, the trainer may identify whether an overlapping degree of areas, in which a feature importance satisfies the designated condition (e.g., a feature importance greater than or equal to 0.8), is greater than or equal to a threshold degree (e.g., 0.5), as identification of whether the designated condition is satisfied. There is no limitation on the designated condition described above.

If the training data does not satisfy the designated condition (No in operation 807), the trainer may perform additional adjustment to the training data in operation 809. In an example, the trainer may change the shape of the identified area, as additional adjustment. For example, the identified area may have a rectangular shape, but the shape of the first identified area being a rectangle is merely an example, and the shape is not limited. The trainer may change the rectangular shape to another shape (may be, for example, a triangle, a circle, or a diamond, but not limited thereto). In an example, the trainer may change the size of the identified area, as additional adjustment. In an example, the trainer may move the identified area, as additional adjustment. For example, the trainer may iteratively perform further adjustments until the designated condition is satisfied. Alternatively, the trainer may discard the corresponding training data if the designated condition is not satisfied even after performing additional adjustment a designated number of times. If the designated condition is satisfied (Yes in operation 807), the trainer may train the first AI model by using the training data in operation 811. If the operations of FIG. 8A are performed by a training data management device, the management device may output (or generate, provide, and/or store) the training data by replacing operation 811. According to the above, training data having a relatively low effect of improving performance of the AI model may not be provided, and/or training data having a relatively large effect of improving performance of the AI model may be provided.

FIG. 8B illustrates a flowchart describing an operation method of a trainer according to an embodiment of the disclosure. Since operations 821, 823, 825, and 829 in FIG. 8B have been described with reference to FIG. 8A, detailed descriptions thereof will not be repeated here. If the training data does not satisfy the designated condition (No in operation 827), the trainer may discard the training data in operation 831. For example, the trainer may discard the training data without performing further adjustment to the training data as in the embodiment of FIG. 8A. For example, the trainer may delete the training data from memory (e.g., the memory 130 of FIG. 1).

FIG. 8C is a diagram describing determination on whether training data satisfies a designated condition, according to an embodiment of the disclosure.

According to an embodiment, the generated training data 841 may include multiple black-processed areas 842 and 843. In the embodiment of FIG. 8C, it is described that whether the designated condition is satisfied is determined in relation to training data, and those skilled in the art may understand that determination on whether the designated condition is satisfied may be performed at an activation map level as well as a training data level. Referring to FIG. 8C, the black-processed areas 842 and 843 may overlap each other. In this case, if a ratio of an overlapping area 844 to the entire area (e.g., the area 842 and/or area 843) is smaller than a threshold ratio, it may be determined that the designated condition is not satisfied. For example, if the first area is substantially included in a second area, the trainer may exclude the first area and identify, as training data, an image including only the second area. Alternatively, if the designated condition is not satisfied, the trainer may perform additional adjustment of changing and/or moving the area, and this has no limitation.

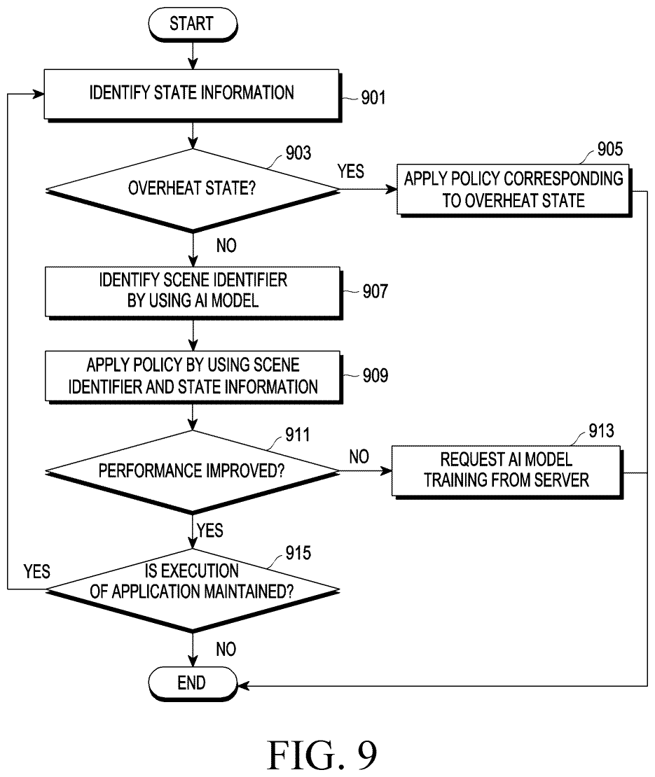

FIG. 9 illustrates a flowchart describing an operation method of the electronic device according to an embodiment of the disclosure.

According to an embodiment, the electronic device 101 (e.g., the processor 120) may identify state information of the electronic device 101 in operation 901. Referring to FIG. 9, the state information may include, for example, at least one temperature associated with the electronic device 101. In operation 903, the electronic device 101 may identify, based on the state information, whether a current state of the electronic device 101 is an overheat state. For example, whether the current state is an overheat state may be determined according to whether temperature is equal to or higher than a threshold temperature, but a condition for determining an overheat state is not limited. If the current state is the overheat state (Yes in operation 903), the electronic device 101 may apply a policy corresponding to the overheat state in operation 905. The policy corresponding to the overheat state may be, for example, restriction on performance (e.g., CPU clock reduction and/or GPU clock reduction) for temperature reduction, but is not limited. If it is identified that the current state is not the overheat state (No in operation 903), the electronic device 101 may identify a scene identifier by using an AI model in operation 907. As described above, the electronic device 101 may identify a scene identifier corresponding to an application execution screen by, for example, inputting the application execution screen to an AI model corresponding to an application running in the foreground. In operation 909, the electronic device 101 may apply the policy by using the scene identifier and the state information. In operation 911, the electronic device 101 may identify whether performance is improved compared to before applying of the policy. A parameter for identification of whether performance is improved may be, for example, an average FPS, a variation value, and an overheat ratio, but there is no limitation on a type thereof. If it is identified that performance has not been improved (No in operation 911), the electronic device 101 may request AI model training from the server 108 in operation 913. For example, no improvement in performance may be due to a classification error in the AI model, and accordingly the server 108 may perform addition training for an existing AI model and/or replace the AI model. In addition, although not illustrated, the electronic device 101 may apply a previous policy again if no improvement in performance is identified. If it is identified that performance has been improved (Yes in operation 911), the electronic device 101 may identify, in operation 915, whether application execution is maintained. When the application ends (No in operation 915), the electronic device 101 may, for example, no longer refer to the AI model.

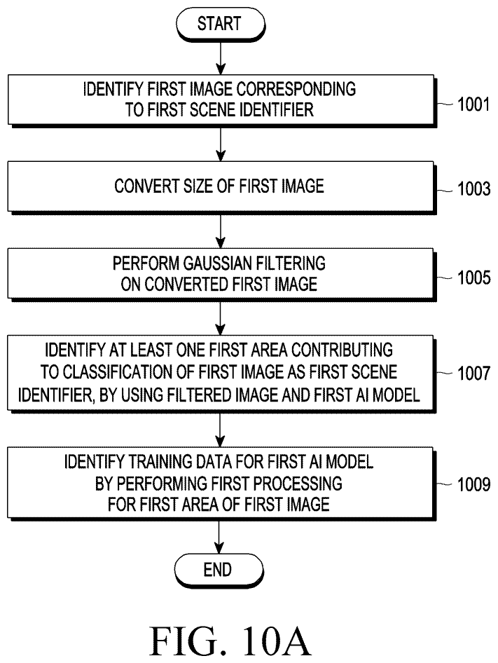

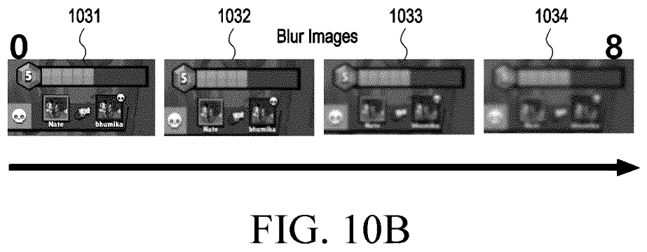

FIG. 10A illustrates a flowchart describing an operation method of a trainer according to an embodiment of the disclosure. The embodiment of FIG. 10A will be described with reference to FIG. 10B. FIG. 10B is a diagram illustrating application of a Gaussian filter according to an embodiment of the disclosure.

According to an embodiment, in operation 1001, the trainer may identify a first image corresponding to a first scene identifier. In operation 1003, the trainer may convert a size of the first image. For example, the trainer may reduce the first image so as to have a size of N×M, but the size of the converted image is not limited and may be enlarged. In operation 1005, the trainer may perform Gaussian filtering on the converted first image. Referring to FIG. 10B, blurred images 1032, 1033, and 1034 may be generated by applying Gaussian filtering to the first image 1031 with various blurring degrees. According to performing of Gaussian filtering, text included in the first image 1031 may be blurred. For example, the trainer may determine a blurring degree (e.g., a σ value of Gaussian filtering may be determined to be one of 0 to 8), based on attributes (may be, for example, a size, a color, and/or a quality, but not limited to) of the text in the first image 1031, but determination of the blurring degree is not limited thereto. Gaussian filtering is merely an example, and there is no limitation on a scheme for blurring. The trainer may perform blurring on the entire first image 1031, or may be configured to perform blurring only on a partial area (e.g., an area including text). In operation 1007, the trainer may identify at least one first area contributing to classification of the first image as the first scene identifier, by using the filtered image and the first AI model. In operation 1009, the trainer may identify training data for the first AI model by performing first processing for the first area of the first image. Since the scheme of identifying at least one first area contributing to classification as the first scene identifier and/or the first processing for the first area have been described above, descriptions thereof will not be repeated here.

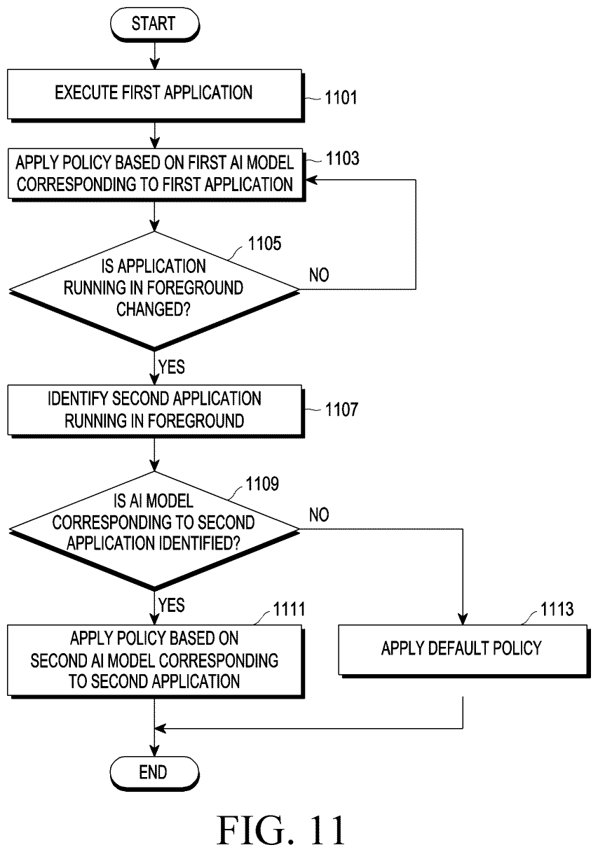

FIG. 11 illustrates a flowchart describing an operation method of the electronic device according to an embodiment of the disclosure.

According to an embodiment, in operation 1101, the electronic device 101 (e.g., the processor 120) may execute a first application. In operation 1103, the electronic device 101 may apply a policy, based on a first AI model corresponding to the first application. As described above, the electronic device 101 may identify an AI model corresponding to an application, and accordingly, may identify the first AI model corresponding to the first application. The electronic device 101 may identify a scene identifier corresponding to an execution screen of the first application by using the first AI model. The electronic device 101 may determine and apply a policy, based on the identified scene identifier and state information. In operation 1105, the electronic device 101 may identify whether the application running in the foreground is changed. If the application running in the foreground is not changed (No in operation 1105), the electronic device 101 may apply the policy, based on the first AI model. If the application running in the foreground is changed (Yes in operation 1105), the electronic device 101 may identify, in operation 1107, a second application running in the foreground. In operation 1109, the electronic device 101 may identify whether an AI model corresponding to the second application is identified. For example, if a type of the second application is a designated type (e.g., game), the electronic device 101 may identify whether an AI model is identified. The electronic device 101 may identify whether the type of the second application is the designated type, by inquiring of the server 108. An AI model for each application may be or may not be stored in the electronic device 101. If a second AI model corresponding to the second application is identified (Yes in operation 1109), the electronic device 101 may apply the policy, in operation 1111, based on the second AI model corresponding to the second application. The electronic device 101 may identify a scene identifier corresponding to an execution screen of the second application by using the second AI model. The electronic device 101 may determine and apply a policy, based on the identified scene identifier and state information. If the second AI model corresponding to the second application is not identified (No in operation 1109), the electronic device 101 may apply a default policy in operation 1113. Alternatively, if the second AI model corresponding to the second application is not identified, the electronic device 101 may request the second AI model corresponding to the second application from the server 108. When the second AI model corresponding to the second application is received from the server 108, the electronic device 101 may apply the policy, based on the second AI model corresponding to the second application. If the second AI model corresponding to the second application is not received from the server 108, the electronic device 101 may apply the default policy.

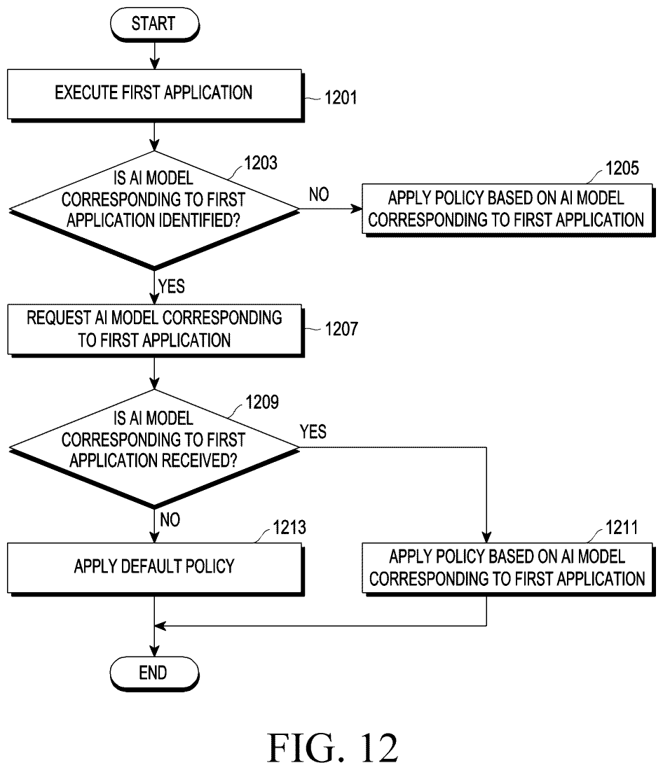

FIG. 12 illustrates a flowchart describing an operation method of the electronic device according to an embodiment of the disclosure.

According to an embodiment, in operation 1201, the electronic device 101 (e.g., the processor 120) may execute a first application. In operation 1203, the electronic device 101 may identify whether an AI model corresponding to the first application is identified. For example, the AI model corresponding to the first application may be or may not be stored in the electronic device 101. If the AI model corresponding to the first application is identified (Yes in operation 1203), the electronic device 101 may apply a policy, in operation 1205, based on the AI model corresponding to the first application. The electronic device 101 may identify a scene identifier corresponding to an execution screen of the first application by using a first AI model. The electronic device 101 may determine and apply a policy, based on the identified scene identifier and state information. If the AI model corresponding to the first application is not identified (No in operation 1203), the electronic device 101 may request, in operation 1207, an AI model corresponding to the first application from an AI model management device (e.g., the server 108). In operation 1209, the electronic device 101 may identify whether the AI model corresponding to the first application is received from the AI model management device (e.g., the server 108). If the AI model corresponding to the first application exists, the model management device (e.g., the server 108) may provide the AI model (or information associated with the AI model) to the electronic device 101 in response to a request from the electronic device 101. When the AI model is received from the model management device (e.g., the server 108) (Yes in operation 1209), the electronic device 101 may apply the policy, in operation 1211, based on the AI model corresponding to the first application. The electronic device 101 may identify the scene identifier corresponding to the execution screen of the first application by using a first AI model. The electronic device 101 may determine and apply the policy, based on the identified scene identifier and state information. If no AI model is received from the model management device (e.g., the server 108) (No in operation 1209), the electronic device 101 may apply a default policy in operation 1213.

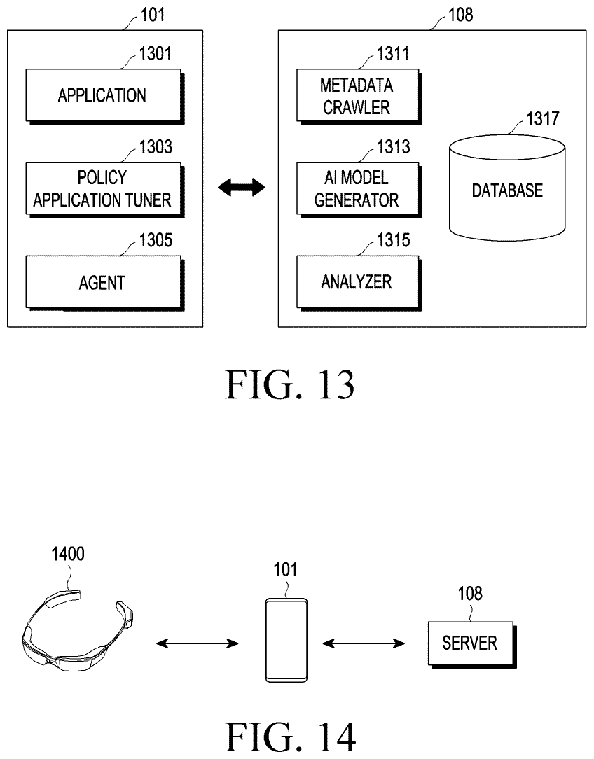

FIG. 13 is a diagram illustrating the electronic device and the server according to an embodiment of the disclosure.

According to an embodiment, the electronic device 101 may store and/or execute an application 1301, a policy application tuner 1303, and/or an agent 1305. At least some of operations performed by the application 1301, the policy application tuner 1303, and/or the agent 1305 may be performed by the processor 120 of the electronic device 101 or by other hardware under the control of the processor 120. The server 108 may include a processor, a memory, and/or a communication module. The server 108 may store and/or execute a metadata crawler 1311, an AI model generator 1313, and an analyzer 1315. At least some of operations performed by the metadata crawler 1311, the AI model generator 1313, and the analyzer 1315 may be performed by the processor of the server 108 or by other hardware under the control of the processor. A database 1317 may be stored, for example, in the memory of the server 108.

According to an embodiment, the policy application tuner 1303 may apply a policy of the electronic device 101. Alternatively, the electronic device 101 may receive a policy from the server 108 and may apply the received policy. The policy application tuner 1303 may collect, store, and/or manage state information during a period corresponding to a scene identifier required for policy determination.

According to an embodiment, the agent 1305 may monitor state information of the electronic device 101. The agent 1305 may identify whether a newly installed application is a type (e.g., game) requiring AI model-based policy determination. The agent 1305 may transmit game-related data to the server 108. The agent 1305 may inquire about whether an AI model corresponding to a specific application exists in the server 108. The agent 1305 may transmit state information to the server 108. The agent 1305 may identify a scene identifier by using an AI model. Based on a scene identifier, the agent 1305 may identify state information to be used for policy determination from among all state information. The agent 1305 may identify a scene identifier by using an AI model. An AI model may receive an image and output a scene identifier. As described above, the electronic device 101 may identify state information to be used for policy determination, based on a scene identifier output from an AI model.

According to an embodiment, the metadata crawler 1311 may crawl application information stored in at least one application store, for example, application information of a designated type. For example, information indicating whether an application is of a designated type (e.g., game) may be crawled, but is not limited. For example, when identification of whether package identification information (e.g., package_name) is of a designated type (e.g., game) is requested, the metadata crawler 1311 may not be able to identify whether the package identification information is of the designated type. In this case, the metadata crawler 1311 may call an API (IS-GAME). Based on the API, lambda via an API gateway may be called. By calling a parser function for at least one application store, lambda may identify whether specific package identification information (e.g., package_name) is of a specific type (e.g., game). A corresponding result may be stored in the database 1317 (e.g., DynamoDB (TB_GAMEPKG)). Later, a request to identify whether the specific package identification information (e.g., package_name) is of a specific type (e.g., game) may be received from the electronic device 101. The server 108 may identify whether the specific package identification information (e.g., package_name) is of a specific type (e.g., game) by referring to the database 1317 (e.g., DynamoDB (TB_GAMEPKG)), and an identification result may be returned to the electronic device 101. The server 108 may provide the electronic device 101 with a basic policy (may be referred to as a configuration default value) and/or an AI model (or information associated with an AI model), as well as determination specific type. The AI model (or information associated with the AI model) may be identified, for example, by referring to the database 1317 (DynamoDBTB_CLASSIFIER).

According to an embodiment, the AI model generator 1313 may generate an AI model for determining a scene identifier. For example, the AI model may receive an image and output a scene identifier. As described above, an inference device may identify state information to be used for policy decision, based on the scene identifier output from the AI model. The AI model generator 1313 may perform additional training. An AI model (or information associated with an AI model) generated by the AI model generator 1313 may be stored in the database 1317. When the server 108 does not store an AI model, an application execution screen for AI model generation may be requested.

According to an embodiment, the analyzer 1315 may determine a policy (or may be referred to as a configuration value) of the electronic device 101 by using state information and a scene identifier. For example, the analyzer 1315 may infer an AI model to identify a scene identifier. The analyzer 1315 may determine the policy of the electronic device 101 and provide the same to the electronic device 101.

According to an embodiment, data associated with game performance may be stored in the database 1317. Data associated with game performance may include unique user identification information (UUID), a reporting time, a duration, an average FPS value, a median FPS value, an FPS variation value, a target FPS variation value, an in-play average FPS value, an in-play FPS variation value, and/or a target in-play FPS variation value, but is not limited.

FIG. 14 is a diagram illustrating operations of a wearable electronic device, the electronic device, and the server according to an embodiment of the disclosure.

According to an embodiment, a wearable electronic device 1400 may interact with the electronic device 101, but such a non-standalone (NSA) mode is an example, and the wearable electronic device 1400 may perform direct communication with the server 108. The wearable electronic device 1400 and/or the electronic device 101 may execute an application (may be, for example, an AR game, but not limited) for the wearable electronic device 1400. An application execution screen may be displayed on the wearable electronic device 1400. The electronic device 101 and/or the wearable electronic device 1400 may input, to an AI model, an image displayed (or transmitted to the wearable electronic device 1400 from the electronic device 101) on the wearable electronic device 1400. The electronic device 101 and/or the wearable electronic device 1400 may identify a scene identifier output from the AI model. Based on the scene identifier, the electronic device 101 and/or the wearable electronic device 1400 may identify state information to be used for policy determination from among all state information.

According to an embodiment, an operation method at an electronic device 101 or 108 may include identifying, by the electronic device, a first image corresponding to a first scene identifier. The operation method of the electronic device may include, by using a first AI (artificial intelligence (AI) model and the first image, identifying, by the electronic device, at least one first area contributing to classification of the first image as the first scene identifier, by using a first AI (artificial intelligence) model and the first image. The operation method of the electronic device may include identifying, by the electronic device, training data for the first AI model by performing first processing for the at least one first area of the first image.

According to an embodiment, the identifying of the at least one first area by using the first AI model and the first image may include identifying an activation map corresponding to the first image. According to an embodiment, the identifying of the at least one first area by using the first AI model and the first image may include identifying the at least one first area, based on the activation map.

According to an embodiment, the identifying of the at least one first area, based on the activation map may include identifying at least one area, in which a feature importance satisfies a designated first condition, in the activation map. According to an embodiment, the identifying of the at least one first area, based on the activation map may include identifying the at least one first area, which corresponds to the at least one area in the activation map, of the first image.

According to an embodiment, the identifying of the at least one area, in which the feature importance satisfies the designated first condition, in the activation map may include, identifying the at least one area in which the feature importance is equal to or greater than a designated threshold feature importance.

According to an embodiment, the identifying of the at least one area, in which the feature importance is equal to or greater than the designated threshold feature importance may include blank-processing remaining areas, in which the feature importance is less than the designated threshold feature importance, in the activation map. According to an embodiment, the identifying of the at least one area in which the feature importance is equal to or greater than the designated threshold feature importance may include configuring at least one contour for the blank-processed remaining areas in the activation map. According to an embodiment, the identifying of the at least one area in which the feature importance is equal to or greater than the designated threshold feature importance may include identifying the at least one area of the activation map, based on the at least one contour.

According to an embodiment, the operation method of the electronic device may include identifying at least one contribution degree, based on an output layer of the AI model and at least one feature map of the AI model. According to an embodiment, the operation method of the electronic device may include identifying multiple feature importances of the activation map, based on the at least one contribution degree and the at least one feature map.

According to an embodiment, the identifying of the at least one contribution degree may be performed based on Equation 1. Equation 1 may be

$${a}_{k}^{c} = \frac{1}{z} {Σ}_{i} {Σ}_{j} \frac{{\partial }_{{y}^{C}}}{\partial {A}_{i , j}^{k}} .$$

The identifying of the multiple feature importances of the activation map may be identified based on Equation 2. Equation 2 may be L^{c}=ReLU Σₖ aₖ^{c}A^{k}. c may be a class of the output layer of the AI model, k may be an index of the at least one feature map, z may be a product of a row and a column of a matrix of the at least one feature map, i may be an i-th element in the matrix, and j may be a j-th element in the matrix.

According to an embodiment, the identifying of the at least one first area may include, identifying at least one area, in which a feature importance satisfies a designated first condition, in the activation map, determining that the at least one area of the activation map satisfies at least one second condition, and identifying the at least one first area of the first image, which corresponds to the at least one area based on the identifying of the at least one area and the determining that the at least one area of the activation map satisfies the at least one second condition.

According to an embodiment, the operation method of the electronic device, the determining that the at least one area of the activation map satisfies at least one second condition may include determining that a size of the at least one area of the activation map is equal to or larger than a designated threshold size.

According to an embodiment, the determining that the at least one second condition is satisfied may include determining that the number of the at least one area of the activation map is equal to or more than a designated threshold number.

According to an embodiment, the determining that the at least one area of the activation map satisfies at least one second condition may include determining that an overlapping degree between the at least one area of the activation map is equal to or less than a threshold overlapping degree.

According to an embodiment, the identifying of the at least one first area may include identifying at least one area, in which a feature importance satisfies a designated first condition, in the activation map, determining that the at least one area of the activation map does not satisfy at least one second condition, and adjusting a shape, a size, and/or a position of at least a part of the at least one area, based on that the at least one area does not satisfy the at least one second condition, based on the identifying of the at least one area and the determining that the at least one area of the activation map does not satisfy the at least one second condition.

According to an embodiment, the identifying of the at least one first area by using the first AI model and the first image may include pre-processing the first image. According to an embodiment, the identifying of the at least one first area by using the first AI model and the first image may include identifying the at least one first area, by using the pre-processed first image and the first AI model.

According to an embodiment, the pre-processing of the first image may include converting a size of the first image. According to an embodiment, the pre-processing of the first image may include performing blurring on the first image.

According to an embodiment, the performing blurring on the first image may include determining a blurring degree based on attributes of at least one text included in the first image, and performing blurring based on the determined blurring degree.

According to an embodiment, an electronic device 101 or 108 may include one or more processors 120 and memory 130 storing one or more computer programs including computer-executable instructions that, when executed by the one or more processors 120, cause the electronic device 101 or 108 to identify a first image corresponding to a first scene identifier. Furthermore, by using a first artificial intelligence (AI) model and the first image, identify at least one first area contributing to classification of the first image as the first scene identifier, and training data for the first AI model by performing first processing for the at least one first area of the first image.

According to an embodiment, the one or more computer programs further comprise computer-executable instructions to, as at least a part of the identifying of the at least one first area by using the first AI model and the first image, identify an activation map corresponding to the first image, and based on the activation map.

According to an embodiment, the one or more computer programs further comprise computer-executable instructions to, as at least a part of the identifying of the at least one first area, based on the activation map, identify at least one area, in which a feature importance satisfies a designated first condition, in the activation map, and identify the at least one first area, which corresponds to the at least one area in the activation map, of the first image.

According to an embodiment, the one or more computer programs further comprise computer-executable instructions to, identify the at least one area in which the feature importance is equal to or greater than a designated threshold feature importance, as at least a part of the identifying of the at least one area, in which the feature importance satisfies the designated first condition, in the activation map.

According to an embodiment, the one or more computer programs further comprise computer-executable instructions to, as at least a part of the identifying of the at least one area, in which the feature importance is equal to or greater than the designated threshold feature importance, blank-process remaining areas, in which the feature importance is less than the designated threshold feature importance, in the activation map, configure at least one contour for the blank-processed remaining areas in the activation map, and based on the at least one contour, as at least a part of the identifying of the at least one area, in which the feature importance is equal to or greater than the designated threshold feature importance.

According to an embodiment, the one or more computer programs further comprise computer-executable instructions to, identify at least one contribution degree, based on an output layer of the AI model and at least one feature map of the AI model, and, based on the at least one contribution degree and the feature map.

According to an embodiment, the identifying of the at least one contribution degree may be performed based on Equation 1. Equation 1 may be

$${a}_{k}^{c} = \frac{1}{z} {Σ}_{i} {Σ}_{j} \frac{{\partial }_{{y}^{C}}}{\partial {A}_{i , j}^{k}} .$$

The identifying of the multiple feature importances of the activation map may be identified based on Equation 2. Equation 2 may be L^{c}=ReLU Σₖ aₖ^{c}A^{k}. c may be a class of the output layer of the AI model, k may be an index of the at least one feature map, z may be a product of a row and a column of a matrix of the at least one feature map, and i and j may be an i-th element and a j-th element in the matrix.

According to an embodiment, the one or more computer programs further comprise computer-executable instructions to, as at least a part of the identifying of the at least one first area, identify the at least one first area of the first image, which corresponds to the at least one area, based on that the at least one area of the activation map satisfies at least one second condition.

According to an embodiment, the one or more computer programs further comprise computer-executable instructions to determine that the at least one second condition is satisfied, based on that a size of the at least one area of the activation map is equal to or larger than a designated threshold size.

According to an embodiment, the one or more computer programs further comprise computer-executable instructions to determine that the at least one second condition is satisfied, based on that the number of the at least one area of the activation map is equal to or more than a designated threshold number.

According to an embodiment, the one or more computer programs further comprise computer-executable instructions to determine that the at least one second condition is satisfied, based on that an overlapping degree between the at least one area of the activation map is equal to or less than a threshold overlapping degree.

According to an embodiment, the one or more computer programs further comprise computer-executable instructions to adjust a shape, a size, and/or a position of at least a part of the at least one area, based on that the at least one area does not satisfy the at least one second condition.

According to an embodiment, the one or more computer programs further comprise computer-executable instructions to pre-process the first image, as at least a part of the identifying of the at least one first area by using the first AI model and the first image, and to identify the at least one first area by using the pre-processed first image and the first AI model, as at least a part of the identifying of the at least one first area by using the first AI model and the first image.

According to an embodiment, the one or more computer programs further comprise computer-executable instructions to convert a size of the first image, as at least a part of the pre-processing of the first image, and perform blurring on the converted first image, as at least a part of the pre-processing of the first image.

According to an embodiment, the one or more computer programs further comprise computer-executable instructions to, as at least a part of the performing blurring on the converted first image, determine a blurring degree based on attributes of at least one text included in the first image, and perform the blurring based on the determined blurring degree.

According to an embodiment, one or more non-transitory computer-readable storage media storing one or more computer programs including computer-executable instructions that, when executed by one or more processors 120 of an electronic device 101 or 108, cause the electronic device 101 or 108 to perform operations may be provided. The operations may include identifying, by the electronic device, a first image corresponding to a first scene identifier. Furthermore, by using a first artificial intelligence (AI) model and the first image, identifying, by the electronic device, at least one first area contributing to classification of the first image as the first scene identifier, and identifying training data for the first AI model by performing first processing for changing a pixel value of at least a part of the at least one first area of the first image.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, the method comprising:
identifying, by the electronic device, a first image corresponding to a first scene identifier;
by using a first artificial intelligence (AI) model and the first image, identifying, by the electronic device, at least one first area contributing to classification of the first image as the first scene identifier; and
identifying, by the electronic device, training data for the first AI model, by performing first processing for changing a pixel value of at least a part of the at least one first area of the first image.

2. The method of claim 1, wherein the identifying of the at least one first area by using the first AI model and the first image comprises:
identifying an activation map corresponding to the first image; and
based on the activation map, identifying the at least one first area.

3. The method of claim 2, wherein the identifying of the at least one first area, based on the activation map, comprises:
identifying at least one area, in which a feature importance satisfies a designated first condition, in the activation map; and
identifying the at least one first area, which corresponds to the at least one area in the activation map, of the first image.

4. The method of claim 3, wherein the identifying of the at least one area, in which the feature importance satisfies the designated first condition, in the activation map, comprises identifying the at least one area in which the feature importance is equal to or greater than a designated threshold feature importance.

5. The method of claim 4, wherein the identifying of the at least one area, in which the feature importance is equal to or greater than the designated threshold feature importance, comprises:
blank-processing remaining areas, in which the feature importance is less than the designated threshold feature importance, in the activation map;
configuring at least one contour for the blank-processed remaining areas in the activation map; and
based on the at least one contour, identifying the at least one area of the activation map.

6. The method of claim 2, further comprising:
based on an output layer of the AI model and at least one feature map of the AI model, identifying at least one contribution degree; and
based on the at least one contribution degree and the at least one feature map, identifying multiple feature importances of the activation map.

7. The method of claim 6,
wherein the identifying of the at least one contribution degree is performed based on Equation 1, where Equation 1 is
$${a}_{k}^{c} = \frac{1}{z} {Σ}_{i} {Σ}_{j} \frac{{\partial }_{{y}^{C}}}{\partial {A}_{i , j}^{k}} ,$$
wherein the identifying of the multiple feature importances of the activation map is identified based on Equation 2, where Equation 2 is L^{c}=ReLU Σₖ aₖ^{c}A^{k}, and
wherein c is a class of the output layer of the AI model, k is an index of the at least one feature map, z is a product of a row and a column of a matrix of the at least one feature map, i is an i-th element in the matrix, and j is a j-th element in the matrix.

8. The method of claim 2, wherein the identifying of the at least one first area further comprises:
identifying at least one area, in which a feature importance satisfies a designated first condition, in the activation map;
determining that the at least one area of the activation map satisfies at least one second condition; and
identifying the at least one first area of the first image, which corresponds to the at least one area based on the identifying of the at least one area and the determining that the at least one area of the activation map satisfies the at least one second condition.

9. The method of claim 8, wherein the determining that the at least one area of the activation map satisfies at least one second condition comprises:
determining that a size of the at least one area of the activation map is equal to or larger than a designated threshold size.

10. The method of claim 8, wherein the determining that the at least one area of the activation map satisfies at least one second condition comprises:
determining that a number of the at least one area of the activation map is equal to or more than a designated threshold number.

11. The method of claim 8, wherein the determining that the at least one area of the activation map satisfies at least one second condition comprises:
determining that an overlapping degree between the at least one area of the activation map is equal to or less than a threshold overlapping degree.

12. The method of claim 2, wherein the identifying of the at least one first area further comprises:
identifying at least one area, in which a feature importance satisfies a designated first condition, in the activation map;
determining that the at least one area of the activation map does not satisfy at least one second condition; and
adjusting a shape, a size, and/or a position of at least a part of the at least one area, based on the identifying of the at least one area and the determining that the at least one area of the activation map does not satisfy the at least one second condition.

13. The method of claim 1, wherein the identifying of the at least one first area by using the first AI model and the first image comprises:
pre-processing the first image; and
identifying the at least one first area, by using the pre-processed first image and the first AI model.

14. The method of claim 13, wherein the pre-processing of the first image comprises:
converting a size of the first image; and
performing blurring on the first image.

15. The method of claim 14, wherein the performing blurring on the first image comprises:
determining a blurring degree, based on attributes of at least one text included in the first image; and
performing the blurring based on the determined blurring degree.

16. An electronic device comprising:
memory storing one or more computer programs including computer-executable instructions; and
one or more processors,
wherein the computer-executable instructions, when executed by the one or more processors, cause the electronic device to:
identify a first image corresponding to a first scene identifier,
by using a first artificial intelligence (AI) model and the first image, identify at least one first area contributing to classification of the first image as the first scene identifier, and
identify training data for the first AI model by performing first processing for changing a pixel value of at least a part of the at least one first area of the first image.

17. The electronic device of claim 16, wherein the one or more computer programs further comprise computer-executable instructions to, as at least a part of the identifying of the at least one first area by using the first AI model and the first image:
identify an activation map corresponding to the first image, and
based on the activation map, identify the at least one first area.

18. The electronic device of claim 17, wherein the one or more computer programs further comprise computer-executable instructions to, as at least a part of the identifying of the at least one first area, based on the activation map:
identify at least one area, in which a feature importance satisfies a designated first condition, in the activation map, and
identify the at least one first area, which corresponds to the at least one area in the activation map, of the first image.

19. The electronic device of claim 18, wherein the one or more computer programs further comprise computer-executable instructions to, as at least a part of the identifying of the at least one area, in which the feature importance satisfies the designated first condition, in the activation map, identify the at least one area in which the feature importance is equal to or greater than a designated threshold feature importance.

20. One or more non-transitory computer-readable storage media storing one or more computer programs including computer-executable instructions that, when executed by one or more processors of an electronic device, cause the electronic device to perform operations, the operations comprising:
identifying, by the electronic device, a first image corresponding to a first scene identifier;
by using a first artificial intelligence (AI) model and the first image, identifying, by the electronic device, at least one first area contributing to classification of the first image as the first scene identifier; and
identifying, by the electronic device, training data for the first AI model by performing first processing for changing a pixel value of at least a part of the at least one first area of the first image.
